(19) United States
(12) Patent Application Publication
(10) Pub. No.: US 2011/0001874 A1
(43) Pub. Date: Jan. 6, 2011

(54) FRAME RATE CONVERSION DEVICE AND FRAME RATE CONVERSION METHOD

(76) Inventors: Yoshihito Ohta, Okayama (JP); Katsumi Terai, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/867,123

(22) PCT Filed: Feb. 9, 2009
(86) PCT No.: PCT/JP2009/000506

§ 371 Date: Aug. 11, 2010

(30) Foreign Application Priority Data
Feb. 29, 2008 (JP) 2008-050918

(51) Int. Cl. H04N 7/01

(52) U.S. Cl. 348/448; 348/E07.003

(57) ABSTRACT

When a frame rate is doubled by repeating video signals of respective frames twice and then resultant video signals are supplied to the overdrive circuitry, the number of cases where the effect of overdrive is not sufficiently obtained is likely to increase undesirably. A double-speed conversion section inserts, between video signals of an N-1th frame and an Nth frame following the N-1th frame which are input video signals, an N-1th interpolation frame video signal at a signal level same as that of the N-1th frame video signal, and outputs resultant video signals at a frame rate twice as high as that of the input video signals. An interpolation frame correcting section corrects the N-1th interpolation frame video signal outputted from the double-speed conversion section, in accordance with the signal levels of the N-1th frame video signal and of the Nth frame video signal.

### TECHNICAL FIELD

The present invention relates to a frame rate conversion device and a frame rate conversion method, and more particularly, to a frame rate conversion device and a frame rate conversion method, for a liquid crystal display device including overdrive circuitry.

### BACKGROUND ART

There has conventionally been overdrive technology for improving the response speed of a liquid crystal (e.g., see Patent Literature 1). The overdrive corrects a voltage applied to the liquid crystal so that, a voltage higher than an original voltage is applied to increase the voltage applied to the liquid crystal, and a voltage lower than the original voltage is applied to decrease the voltage applied to the liquid crystal.

In addition, there has conventionally been a technology for preventing blurring caused by motion images in a liquid crystal display device, the technology being frame rate conversion for driving a liquid crystal, using video signals having a frame rate increased by interpolating a new frame between consecutive frames of the video signals. For a frame to be interpolated, there is a case where the frame to be interpolated has the same video signal as that of the preceding frame (i.e., a case where a frame rate is doubled by repeating video signals of respective frames twice) or a case where the frame to be interpolated is generated based on a motion vector which is detected based on a preceding frame and a succeeding frame.

A frame rate conversion method, in which a frame rate is doubled by repeating the video signals of the respective frames twice, is a preferable approach to a case where a still image or a substantially still image (i.e., an image composed greatly of still images) is displayed, for example, on an OSD region or in PC mode. The reason is that, when displaying such image, the motion vector cannot be detected appropriately, and thus, an improper interpolation frame may undesirably be generated.

[Patent Literature 1] Japanese Laid-Open Patent Publication No. 2002-108294

### DISCLOSURE OF THE INVENTION

### Problems To Be Solved By the Invention

It is conceivable that the frame rate conversion technology is applied to video signals to be supplied to the liquid crystal display device including the overdrive circuitry, and a frame rate is doubled by repeating the video signals of respective frames twice and then resultant video signals are supplied to the overdrive circuitry. Accordingly, both advantages of the overdrive and of the frame rate conversion, as described above, may be obtained. FIG. 16 shows an example of video signals before the frame rate conversion. FIG. 17 shows an example of the video signals after the frame rate conversion (i.e., video signals to be actually inputted into the overdrive circuitry). The frame rate conversion inserts, between an N-1th (N is an integer greater than or equal to 2) frame video signal and an Nth frame video signal, an N-1th interpolation frame video signal at a signal level same as that of the N-1th frame video signal.

The overdrive circuitry corrects a video signal of a frame, generally, based on the difference in signal level between video signals of two consecutive frames. For example, when the video signals as shown in FIG. 16 are inputted into the overdrive circuitry, the overdrive circuitry corrects the Nth frame video signal so that the signal level of the Nth frame video signal reaches an ideal level for overdrive, as shown in FIG. 18, based on the difference between the signal level of the N-1th frame video signal and the signal level of the Nth frame video signal.

Note that, the ideal level for overdrive depends not only on the difference in signal level of the video signals of the two consecutive frames, but also on its frame rate. In general, an absolute value of a correction amount of the signal level in overdrive increases with an increase in the frame rate. Consequently, for example, when the video signals as shown in FIG. 17 are inputted into the overdrive circuitry, the overdrive circuitry attempts to correct the Nth frame video signal so that the signal level of the Nth frame video signal reaches the ideal level for overdrive, as shown in FIG. 19. However, the ideal level of the Nth frame video signal undesirably exceeds the upper limit of the signal level of the video signal, and thus, the effect of the overdrive cannot sufficiently be obtained.

That is, when a configuration is employed, in which the frame rate conversion technology is applied to the video signals to be supplied to the liquid crystal display device including the overdrive circuitry, and the frame rate is doubled by repeating each of the video signals of the respective frames twice and then resultant video signals are supplied to the overdrive circuitry, a problem as described above (a problem that a case where the effect of the overdrive cannot be obtained sufficiently is likely to increase) is caused by the application of the frame rate conversion technology, thereby undesirably introducing image quality degradation.

Therefore, an object of the present invention is to provide a frame rate conversion device or a frame rate conversion method, capable of obtaining the effect of the overdrive sufficiently even when the frame rate is doubled by repeating each of the video signals of the respective frames twice, and then the resultant video signals are supplied to the overdrive circuitry.

### Solution To the Problems

In order to achieve the above object, the present invention employs a configuration as follows. Note that, reference characters in parentheses show an example of correspondence with drawings for assistance in understanding the present invention and do not limit the scope of the present invention.

A frame rate conversion device (1) of the present invention includes a frame rate conversion device for a liquid crystal display device (2) including overdrive circuitry (3), the frame rate conversion device (1) including: a double-speed conversion section (10) which inserts, between a video signal of an N-1th frame (N is an integer greater than or equal to 2) and a video signal of an Nth frame following the N-1th frame which are input video signals, a video signal of an N-1th interpolation frame at a signal level same as that of the video signal of the N-1th frame, and which outputs resultant video signals at a frame rate twice as high as that of the input video signals; and an interpolation frame correcting section (20a, 20b, or 20c) which corrects the N-1th interpolation frame video signal outputted from the double-speed conversion section, in accordance with the signal level of the N-1th frame video signal and a signal level of the Nth frame video signal.

The interpolation frame correcting section may correct the N-1th interpolation frame video signal outputted from the double-speed conversion section so that the signal level of the N-1th interpolation frame video signal becomes close to the signal level of the Nth frame video signal (FIG. 5, FIG. 6, FIG. 15).

The interpolation frame correcting section may include: a correction amount determining section (40) which determines a correction amount (a) of the N-1th interpolation frame video signal, in accordance with the signal level of the N-1th frame video signal and the signal level of the Nth frame video signal; and a correction section (50) which corrects the N-1th interpolation frame video signal outputted by the double-speed conversion section, in accordance with the correction amount determined by the correction amount determining section.

The correction amount determining section includes: a difference calculating section (401) which calculates a difference between the signal level of the Nth frame video signal and the signal level of the N-1th frame video signal by subtracting the signal level of the N-1th frame video signal from the signal level of the Nth frame video signal; and a multiplication section (402) which multiplies the difference calculated by the difference calculating section by a predetermined correction factor (K, FIG. 3, FIG. 8). The correction section may correct the N-1th interpolation frame video signal by adding a multiplication result obtained by the multiplication section to the signal level of the N-1th interpolation frame video signal outputted by the double-speed conversion section.

The predetermined correction factor (K) may be a value other than 0.5.

The correction amount determining section may determine the correction amount of the N-1th frame video signal by referring to a lookup table (404) defining correspondence between the correction amount (a) of the N-1th interpolation frame video signal and combination of the signal level of the N-1th frame video signal (A) and the signal level of the Nth frame video signal (B).

The frame rate conversion device further includes a correction necessity evaluating section (60) which evaluates whether an ideal level of the Nth frame video signal, in a condition where overdrive is performed by directly inputting into the overdrive circuitry the video signal outputted by the double-speed conversion section, falls within a video signal range from a lower limit level (0%) to an upper limit level (100%). The interpolation frame correcting section may correct the N-1th interpolation frame video signal outputted by the double-speed conversion section only when the ideal level is evaluated not to fall within the range by the correction necessity evaluating section.

The frame rate conversion device further includes a validation section (70) which validates whether an ideal level of Nth frame video signal, in a condition where overdrive is performed by inputting into the overdrive circuitry the video signal to be outputted by the frame rate conversion device, falls within the video signal range from a lower limit level (0%) to an upper limit level (100%). The interpolation frame correcting section may correct the N-1th interpolation frame video signal outputted by the double-speed conversion section, based on a validation result obtained by the validation section, so that the ideal level of the Nth frame video signal, in a condition where the overdrive is performed by inputting into the overdrive circuitry the video signal to be outputted by the frame rate conversion device, falls within the range. Note that, the validation section may be realized as a part of functions of the aforementioned correction amount determining section.

The interpolation frame correcting section may correct the N-1th interpolation frame video signal outputted from the double-speed conversion section, based on the validation result obtained by the validation section, by using a bare minimum correction amount (a) at which the ideal level of the Nth frame video signal, in a condition where overdrive is performed by inputting into the overdrive circuitry the video signals to be outputted by the frame rate conversion device, falls within the range (FIG. 15).

The interpolation frame correcting section may correct each video signal per pixel unit, per plurality of pixels unit, or per frame unit.

A frame rate conversion method of the present invention includes a frame rate conversion method for a liquid crystal display device including overdrive circuitry, the frame rate conversion method including: a double-speed conversion step of inserting, between a video signal of an N-1th frame (N is an integer greater than or equal to 2) and a video signal of an Nth frame following the N-1th frame which are input video signals, an N-1th interpolation frame video signal at a signal level same as that of the N-1th frame video signal, and outputting resultant video signals at a frame rate twice as high as that of the input video signals; and an interpolation frame correcting step of correcting the N-1th interpolation frame video signal inserted by the double-speed conversion step, in accordance with the signal level of the N-1th frame video signal and a signal level of the Nth frame video signal.

### Effect of the Invention

According to the present invention, the effect of the overdrive may be obtained sufficiently even when the frame rate is doubled by repeating each of the video signals of the respective frames twice and then the resultant video signals are supplied to the overdrive circuitry.

### BRIEF DESCRIPTION OF THE DRAWINGS

FIG. 1 is a diagram showing an entire structure of a display system using a frame rate conversion device according to an embodiment of the present invention.

FIG. 2 is a diagram showing a configuration of the frame rate conversion device.

FIG. 3 is a diagram showing an example of a configuration of a correction amount determining section.

FIG. 4 is a diagram showing signals to be processed in the frame rate conversion device.

FIG. 5 is a diagram showing output video signals.

FIG. 6 is a diagram showing an ideal level of an Nth frame video signal for overdrive based on the output video signals in FIG. 5.

FIG. 7 is a diagram showing, as an unpreferable case, the output video signals where a correction factor is 0.5.

FIG. 8 is a diagram showing a modified example of the correction amount determining section.

FIG. 9 is a diagram showing another modified example of the correction amount determining section.

FIG. 10 is a diagram showing an example of a lookup table.

FIG. 11 is a diagram showing a modified example of an interpolation frame correcting section.

FIG. 12 is a diagram showing a configuration of a correction necessity evaluating section.

FIG. 13 is a diagram showing another modified example of the interpolation frame correcting section.

FIG. 14 is a diagram showing a configuration of a validation section.

FIG. 15 is a diagram showing the ideal level of the Nth frame video signal for overdrive based on video signals outputted from the validation section.

FIG. 16 is a diagram showing an example of the video signals before frame rate conversion.

FIG. 17 is a diagram showing an example of the video signals after the frame rate conversion.

FIG. 18 is a diagram showing the ideal level of the Nth frame video signal for overdrive based on the output video signals in FIG. 16.

FIG. 19 is a diagram showing the ideal level of the Nth frame video signal for overdrive based on the output video signals in FIG. 17.

### DESCRIPTION OF THE REFERENCE CHARACTERS

1 frame rate conversion device

2 liquid crystal display device

3 overdrive circuitry

10 double-speed conversion section

20a, 20b, 20c interpolation frame correcting section

30 1 F delay section

40, 40a, 40b, 40c correction amount determining section

50 correction section

60 correction necessity evaluating section

70 selection section

80 correction amount determining section

90 validation section

401 difference calculating section

402 multiplication section

403 correction factor determining section

404 lookup table

601 ideal level evaluating section

602 comparison section

901 ideal level evaluating section

902 comparison section

903 output section

### BEST MODE FOR CARRYING OUT THE INVENTION

The following describes an embodiment of the present invention with reference to the accompanying drawings.

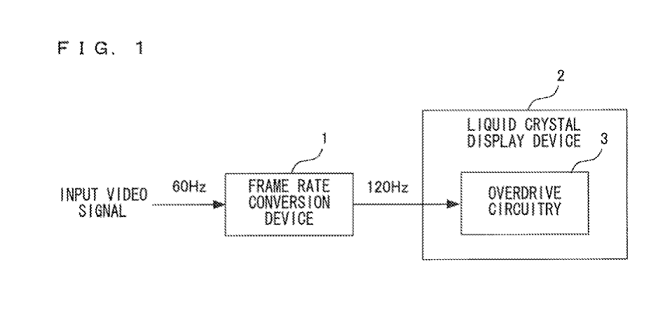

FIG. 1 shows an entire structure of a display system using a frame rate conversion device according to an embodiment of the present invention. A frame rate conversion device 1 performs frame rate conversion to converts input video signals having frame frequency of 60 Hz into video signals having the frame frequency of 120 Hz, and, if necessary, corrects the converted video signals. A liquid crystal display device 2 includes overdrive circuitry 3. The video signals to be outputted from the frame rate conversion device 1 (the video signals having the frame frequency of 120 Hz) are inputted into the overdrive circuitry 3. Note that, the frame rate conversion device 1 may be provided inside the liquid crystal display device 2. Also, the overdrive circuitry 3 may be provided outside the liquid crystal display device 2.

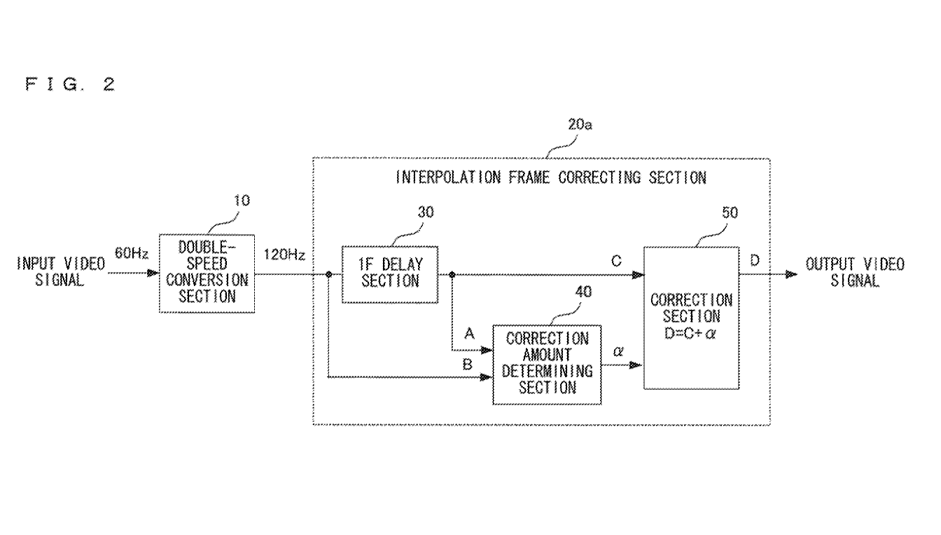

FIG. 2 shows a configuration of the frame rate conversion device 1.

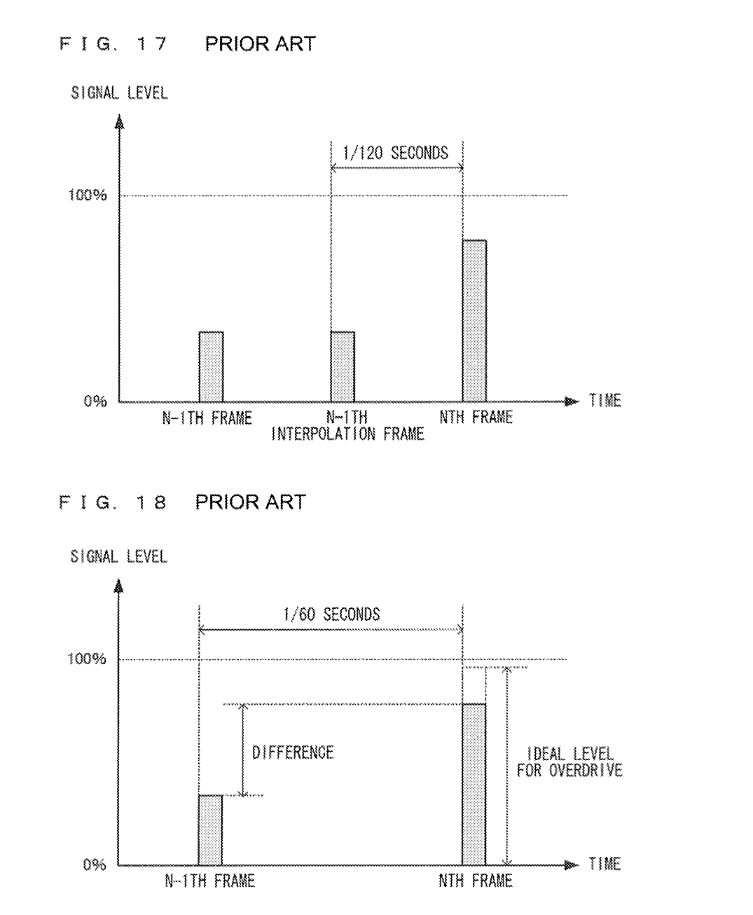

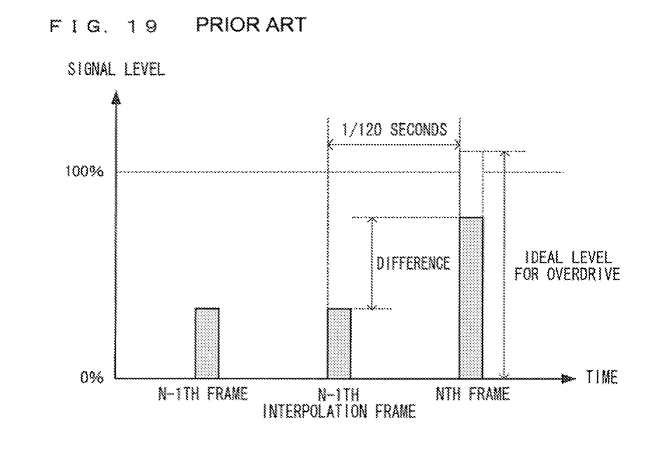

A double-speed conversion section 10 doubles the frame rate of the input video signals having the frame frequency of 60 Hz by repeating each of the video signals of the respective frames twice, and outputs resultant video signals having the frame frequency of 120 Hz. For example, when video signals as shown in FIG. 16 are inputted into the double-speed conversion section 10, an N-1th (N is an integer greater than or equal to 2) interpolation frame at a signal level same as that of an N-1th frame video signal is inserted between the N-1th frame video signal and an Nth frame video signal in the double-speed conversion section 10. Consequently, video signals as shown in FIG. 17 are outputted by the double-speed conversion section 10.

An interpolation frame correcting section 20a corrects, if necessary, the N-1th interpolation frame video signal outputted from the double-speed conversion section 10, in accordance with the signal level of the N-1th frame video signal and the signal level of the Nth frame video signal. More specifically, the interpolation frame correcting section 20a corrects the N-1th interpolation frame video signal so that the signal level of the N-1th interpolation frame video signal becomes close to the signal level of the Nth frame video signal.

The interpolation frame correcting section 20a includes a 1 F delay section 30, a correction amount determining section 40, and a correction section 50. The 1 F delay section 30 delays the video signals inputted into the interpolation frame correcting section 20a (the video signals outputted from the double-speed conversion section 10), by one frame (here, 1/120 seconds). The correction amount determining section 40 determines a correction amount α according to a video signal B inputted into the interpolation frame correcting section 20a and a video signal A outputted from the 1 F delay section 30. The correction section 50 adds the correction amount α determined by the correction amount determining section 40 to a video signal C inputted into the correction section 50 (i.e., the video signal A outputted from the 1 F delay section 30) thereby to correct the video signal C and output resultant video signals as output video signals D. 100311 Note that, the correction of the video signals by the interpolation frame correcting section 20a is performed per pixel unit. That is, the correction amount determining section 40 determines a correction amount α corresponding to each one of pixels, in accordance with a signal level of a pixel in the video signal B inputted into the interpolation frame correcting section 20a and a signal level of a pixel in the video signal A outputted from the 1 F delay section 30, in which the pixel in the video signal A corresponds to the pixel in the video signal B. The correction section 50 then corrects a signal level of a pixel in the video signal C inputted into the correction section 50, based on the correction amount α determined by the correction amount determining section 40, the correction amount α corresponds to respective pixels.

Note that, the correction of the video signals is not limited to be performed per pixel unit, and may be performed per block unit, per line unit, or per column unit, which are formed of a plurality of pixels, or per frame unit which is an entire screen. For example, when the correction of the video signals is performed per block unit, the correction amount determining section 40 determines a correction amount corresponding to each one of blocks, in accordance with an average signal level of pixels in a block of the video signal B inputted into the interpolation frame correcting section 20a and an average signal level of pixels in a block of the video signal A outputted from the 1 F delay section 30, in which the block of the video signal A corresponds to the block of the video signal B. The correction section 50 then corrects a signal level of a pixel contained in a block of the video signal C inputted into the correction section 50, based on the correction amount determined by the correction amount determining section 40, the correction amount corresponds to respective blocks.

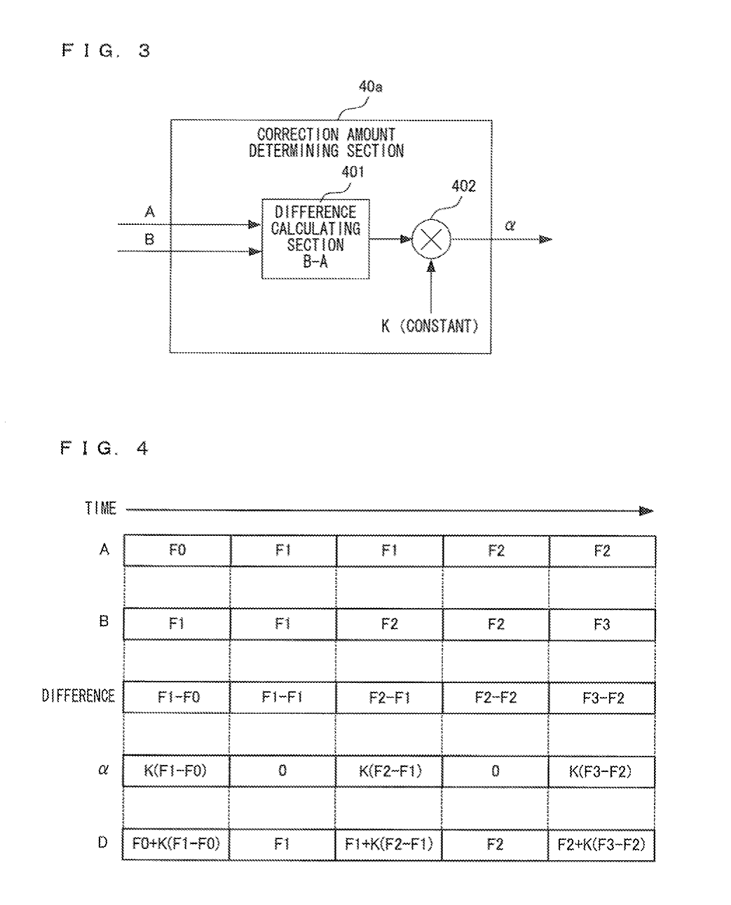

FIG. 3 shows an example of the correction amount determining section 40 (a reference character 40a is used to distinguish this example with other modified examples to be described later). The correction amount determining section 40a includes a difference calculating section 401 and a multiplication section 402. The difference calculating section 401 calculates a difference (B−A) between the signal level of the video signal B inputted into the interpolation frame correcting section 20a and the signal level of the video signal A outputted from the 1 F delay section 30. The multiplication section 402 multiplies the difference outputted from the difference calculating section 401 by a correction factor K (a constant value greater than 0 and smaller than 1) and outputs a value of a multiplication result as the correction amount α.

FIG. 4 shows signals at components in the interpolation frame correcting section 20a. Note that, F0, F1, F2 and F3 in FIG. 4 correspond to frame numbers indicative of the respective video signals inputted into the double-speed conversion section 10. The video signal B inputted into the interpolation frame correcting section 20a is a video signal obtained by repeating each video signal twice. The video signal A outputted from the 1 F delay section 30 is one-frame delayed relative to the video signal B inputted into the interpolation frame correcting section 20a. The correction amount α is a value obtained by subtracting the signal level of the video signal A from the signal level of the video signal B and multiplying a resultant value by the correction factor K. A video signal D outputted from the interpolation frame correcting section 20a is obtained by adding the correction amount α to the signal level of the video signal A.

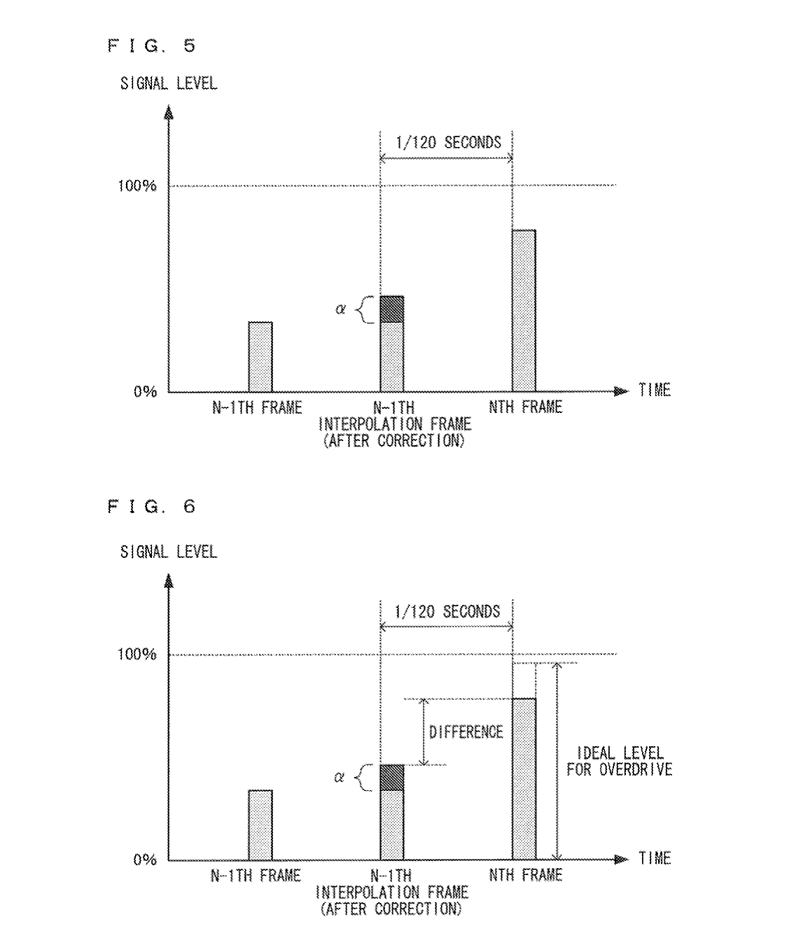

FIG. 5 shows a specific example of the video signals D outputted from the interpolation frame correcting section 20a (i.e., the video signals to be supplied from the frame rate conversion device 1 to the overdrive circuitry 3). The signal level of the N-1th interpolation frame video signal is changed by the correction amount α and outputted, by the interpolation frame correcting section 20a. As described above, the correction amount α is calculated by subtracting the signal level of the N-1th interpolation frame video signal (before correction) from the signal level of the Nth frame video signal and multiplying the resultant value by the correction factor K. To put it differently, considering that the signal level of the N-1th interpolation frame video signal (before correction) is the same as the signal level of the N-1th frame video signal, the correction amount α is calculated by subtracting the signal level of the N-1th frame video signal from the signal level of the Nth frame video signal and multiplying a resultant value by the correction factor K.

When the video signals D as shown in FIG. 5 are supplied to the overdrive circuitry 3, the video signals of respective frames are corrected in the overdrive circuitry 3, based on a difference in signal level between the video signals of two consecutive frames. When the video signals as shown in FIG. 5 are inputted into the overdrive circuitry 3, the overdrive circuitry 3 corrects the Nth frame video signal so that the signal level of the Nth frame video signal reaches an ideal level for overdrive, as shown in FIG. 6, based on the difference between the signal level of the N-1th interpolation frame video signal and the signal level of the Nth frame video signal. Because the N-1th interpolation frame video signal is corrected so that the signal level of the N-1th interpolation frame video signal becomes close to the signal level of the Nth frame video signal in the interpolation frame correcting section 20a of the frame rate conversion device 1, the difference between the signal level of the N-1th interpolation frame video signal and the signal level of the Nth frame video signal is reduced in an example in FIG. 6 as compared to an example in FIG. 19. Consequently, the ideal level of the Nth frame video signal does not exceed the upper limit of the signal level of the video signal, and thus, the effect of the overdrive is sufficiently obtained.

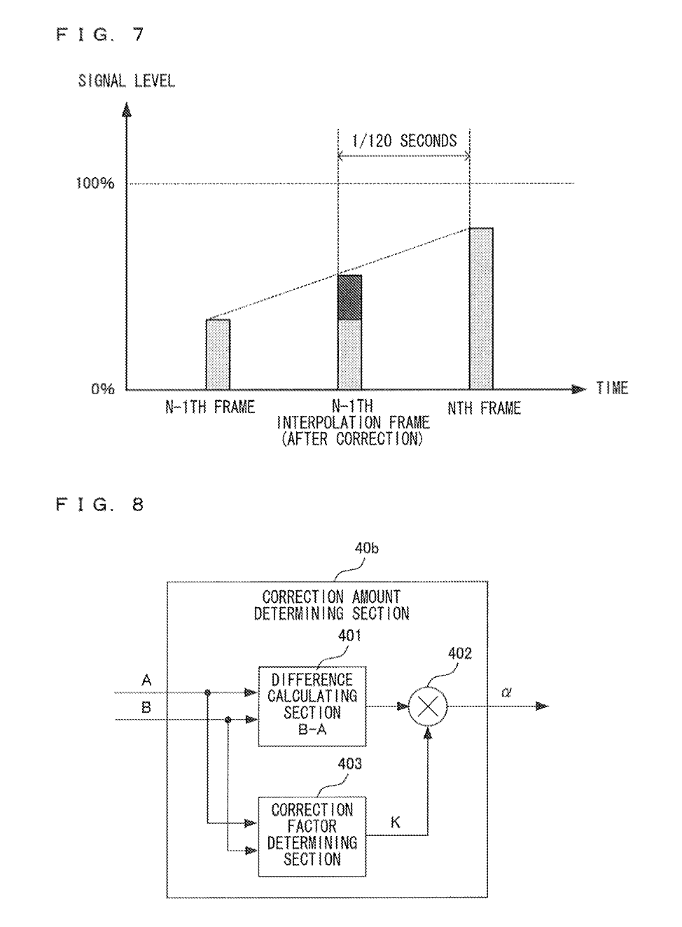

Note that, in the correction amount determining section 40 of the interpolation frame correcting section 20a, the difference value outputted from the difference calculating section 401 is multiplied by the correction factor K (a constant value greater than 0 and smaller than 1) in the multiplication section 402, and, preferably, this correction factor K is a value other than 0.5. In a case where the correction factor K is 0.5, the signal level of the N-1th interpolation frame video signal undesirably takes an intermediate value between the signal level of the N-1th frame video signal and the signal level of the Nth frame video signal as shown in FIG. 7. In this case, a video image undesirably looks blurred like when the response speed of the liquid crystal is deteriorated, which is unpreferable.

Note that, the correction factor K does not need to be constant and may be changed depending on the signal levels of the input video signals. The following describes a modified example of the correction amount determining section 40 of the case when the correction factor K is changed according to the signal levels of the input video signals.

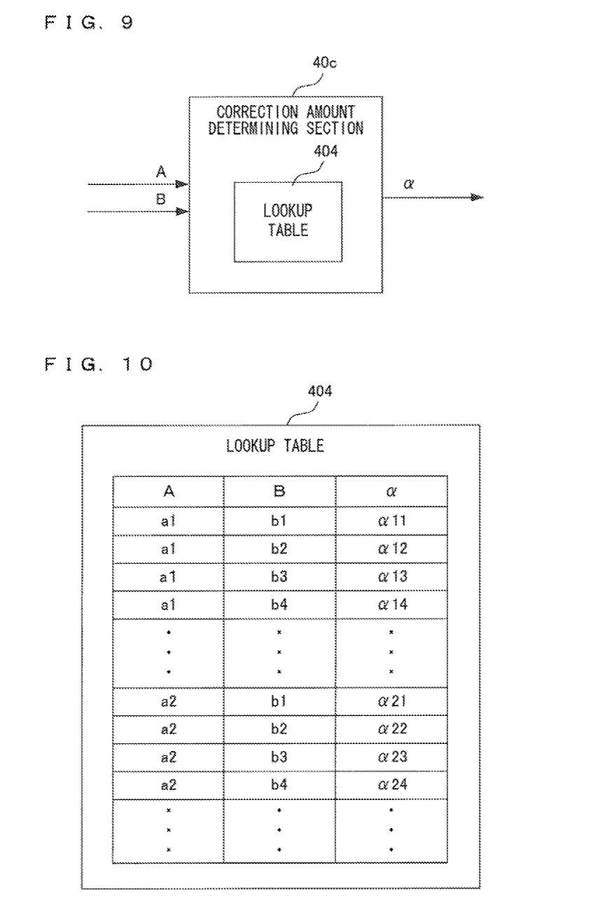

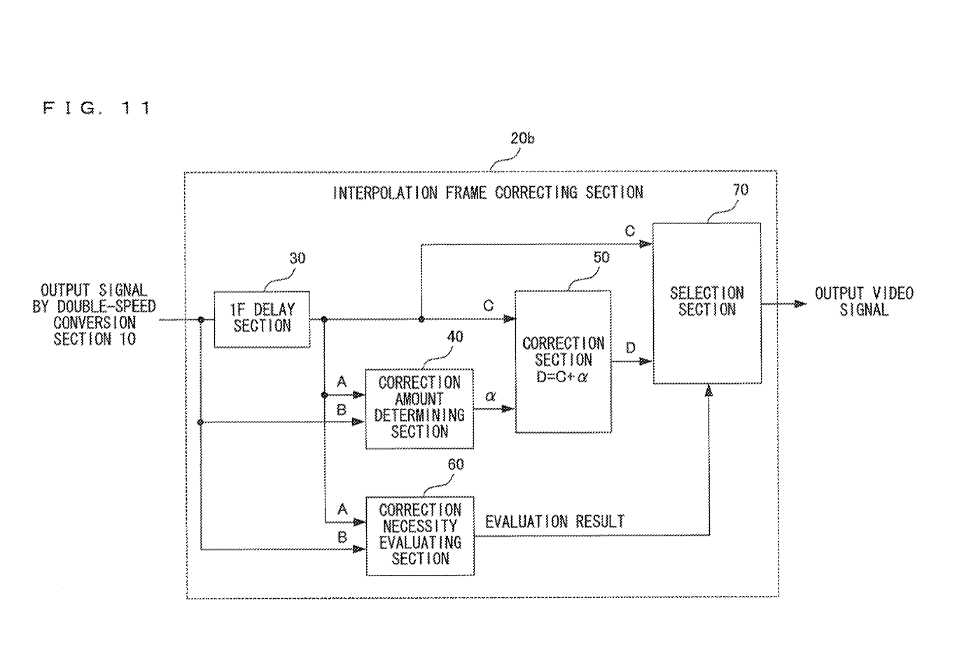

The correction amount determining section 40b shown in FIG. 8 includes the difference calculating section 401, the multiplication section 402, and a correction factor determining section 403. The difference calculating section 401 and the multiplication section 402 have already been described with reference to FIG. 3, and thus the description thereof will be omitted. The correction factor determining section 403 determines the correction factor K in accordance with the video signal A outputted from the 1 F delay section 30 and the video signal B inputted into the interpolation frame correcting section 20a. The correction factor K may be determined based on information such as the signal level of the N-1th interpolation frame video signal, the signal level of the Nth frame video signal, or the difference between these signal levels. Accordingly, on the basis of, for example, the above information, it is possible to increase the correction factor K if the ideal level of the Nth frame video signal for overdrive is expected to exceed the upper limit of the signal level of the video signal, and if not, it is possible to decrease the correction factor K. The correction factor determining section 403 is capable of determining the correction factor K by referring to a lookup table which associates, as an example, the correction factor K with the combination of the signal level of the video signal A and the signal level of the video signal B. As another example of the correction amount determining section 40, a correction amount determining section 40c having a configuration as shown in FIG. 9 may be used. The correction amount determining section 40c in FIG. 9 determines the correction amount α by referring to a lookup table 404 which associates the correction amount α and the combination of the signal level of the video signal A and the signal level of the video signal B (FIG. 10).

### Modified Example of the Interpolation Frame Correcting Section

In the aforementioned interpolation frame correcting section 20a, it is not determined whether the N-1th interpolation frame needs to be corrected (i.e., whether the ideal level of the Nth frame for overdrive falls outside the video signal range from the lower limit level (0%) to the upper limit level (100%) when the N-1th interpolation frame is supplied to the overdrive circuitry 3 without being corrected). Consequently, the N-1th interpolation frame can be undesirably corrected although the correction is unnecessary. Such useless correction thus can lead to image quality degradation. Therefore, the following describes a modified example of the interpolation frame correcting section which can solve such a problem.

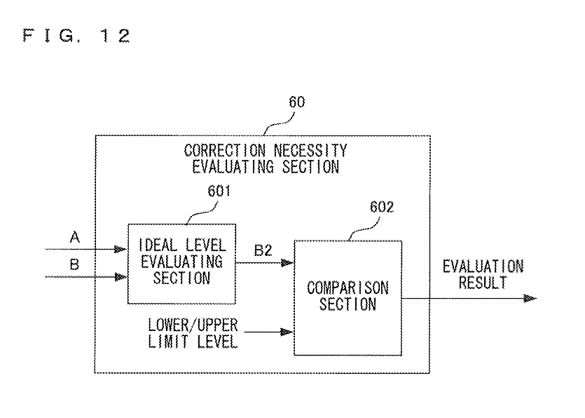

The interpolation frame correcting section 20b shown in FIG. 11 includes the 1 F delay section 30, the correction amount determining section 40, the correction section 50, a correction necessity evaluating section 60, and a selection section 70. The 1 F delay section 30, the correction amount determining section 40 and the correction section 50 have already been described with reference to FIG. 2, and thus the description thereof will be omitted. The correction necessity evaluating section 60 evaluates whether the video signal A needs to be corrected, in accordance with the video signal A outputted from the 1 F delay section 30 and the video signal B inputted into the interpolation frame correcting section 20a (i.e., whether the ideal level of the video signal B for overdrive falls outside the video signal range from the lower limit level to the upper limit level when the video signal A is supplied to the overdrive circuitry 3 without being corrected). Details of the correction necessity evaluating section 60 will be described later. The selection section 70 selects according to an evaluation result obtained by the correction necessity evaluating section 60, either the video signal C (i.e., the video signal A outputted from the 1 F delay section 30) or the video signal D outputted from the correction section 50, and then outputs the selected signal as an output video signal. Specifically, if it is determined that the video signal A needs to be corrected, the selection section 70 outputs the video signal D outputted from the correction section 50 and, if not, the selection section 70 outputs the video signal C.

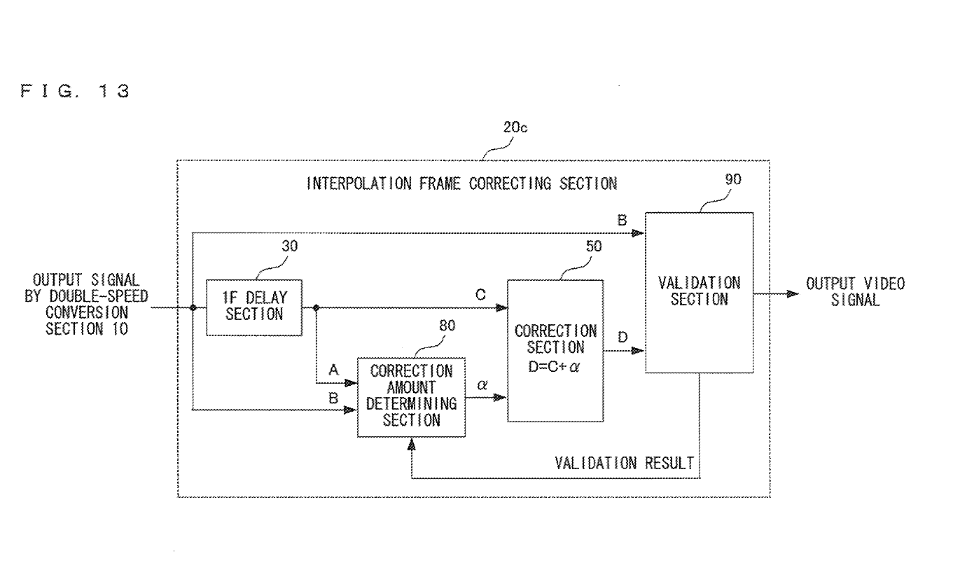

FIG. 12 shows a configuration of the correction necessity evaluating section 60. The correction necessity evaluating section 60 includes an ideal level evaluating section 601 and a comparison section 602. The ideal level evaluating section 601 evaluates the ideal level of the video signal B for overdrive in a condition where the video signal A is supplied to the overdrive circuitry 3 without being corrected. Preferably, this evaluation in the ideal level evaluating section 601 uses the same algorithm as that used for the method of evaluating the ideal level of the video signal B in the overdrive circuitry 3. The comparison section 602 determines whether the video signal A needs to be corrected, by comparing an ideal level B2 of the video signal B, which is evaluated by the ideal level evaluating section 601, and the lower/upper limit levels of the video signal, and outputs a signal indicative of a determination result. Specifically, the comparison section 602 determines that the video signal A needs to be corrected when the ideal level B2 of the video signal B falls outside the video signal range from the lower limit level to the upper limit level, and determines that the video signal A does not need to be corrected when the ideal level B2 of the video signal B falls within the video signal range from the lower limit level to the upper limit level.

The above configuration allows the interpolation frame correcting section 20b to correct the N-1th interpolation frame only when the N-1th interpolation frame needs to be corrected, and thus useless correction which can lead to the image quality degradation can be prevented.

### Other Modified Example of the Interpolation Frame Correcting Section

In the interpolation frame correcting section 20a and the interpolation frame correcting section 20b, it is not validated how the ideal level of the Nth frame video signal for overdrive changes when the N-1th interpolation frame video signal is corrected. Consequently, even if the N-1th interpolation frame video signal is corrected in the interpolation frame correcting section 20a or the interpolation frame correcting section 20b, the ideal level of the Nth frame video signal for overdrive is not guaranteed to fall within the video signal range from the lower limit level to the upper limit level. Therefore, the following describes a modified example of the interpolation frame correcting section which can solve such a problem.

The interpolation frame correcting section 20c shown in FIG. 13 includes the 1 F delay section 30, a correction amount determining section 80, the correction section 50, and a validation section 90. The 1 F delay section 30 and the correction section 50 have already been described with reference to FIG. 2, and thus the description thereof will be omitted. The correction amount determining section 80 is the same as the correction amount determining section 40 in FIG. 2 in that the correction amount determining section 80 determines the correction amount α in accordance with the video signal B inputted into the interpolation frame correcting section 20a and the video signal A outputted from the 1 F delay section 30. The correction amount determining section 80 differs from the correction amount determining section 40 in FIG. 2 in that the correction amount determining section 80 updates, if necessary, the correction amount α which has once been determined, based on a validation result obtained by the validation section 90. The validation section 90 validates according to the video signal D outputted from the correction section 50 and the video signal B inputted into the interpolation frame correcting section 20a, whether the ideal level of the video signal B for overdrive falls within the video signal range from the lower limit level to the upper limit level, and if the ideal level falls within the range, the validation section 90 outputs the video signal D as the output video signal. Note that, if the validation result by the validation section 90 indicates that the ideal level of the video signal B for overdrive falls outside the video signal range from the lower limit level to the upper limit level, the correction amount determining section 80 updates the correction amount α upon receiving this validation result. An example of the method of updating the correction amount α in the correction amount determining section 80 is a method of adding a predetermined constant value to the correction amount α or subtracting the predetermined constant value from the correction amount α. Other methods may be used for the update.

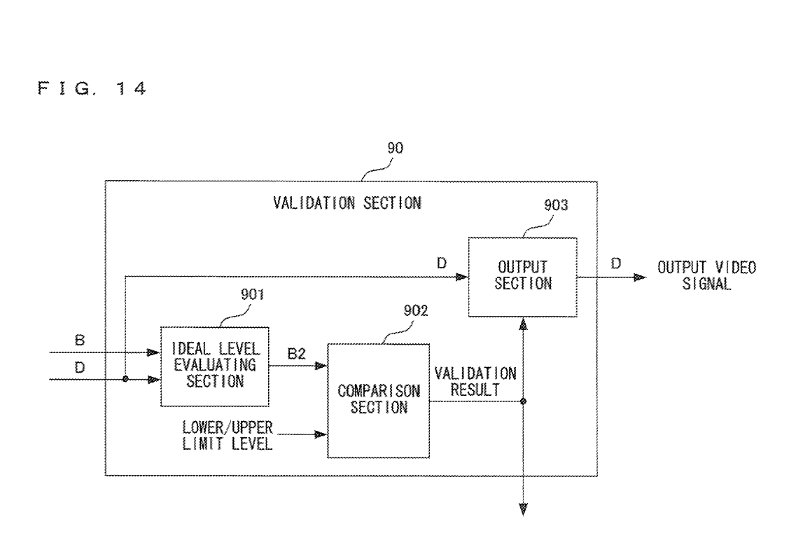

FIG. 14 shows a configuration of the validation section 90. The validation section 90 includes an ideal level evaluating section 901, a comparison section 902, and an output section 903. The ideal level evaluating section 901 evaluates the ideal level of the video signal B for overdrive in a condition where the video signal D outputted from the correction section 50 is supplied to the overdrive circuitry 3. Preferably, this evaluation in the ideal level evaluating section 901 uses the same algorithm as that used for the method of evaluating the ideal level of the video signal B in the overdrive circuitry 3. The comparison section 902 compares the ideal level B2 of the video signal B evaluated by the ideal level evaluating section 901 with the lower/upper limit levels of the video signal to validate whether the ideal level B2 of the video signal B falls within the video signal range from the lower limit level to the upper limit level. This validation result is notified to the output section 903 and the correction amount determining section 80. Upon receiving confirmation in the comparison section 902 that the ideal level B2 of the video signal B has fallen with the video signal range from the lower limit level to the upper limit level, the output section 903 outputs the video signal D as the output video signal.

Note that, when it has been confirmed in the comparison section 902 that the ideal level B2 of the video signal B has fallen outside the video signal range from the lower limit level to the upper limit level, the correction amount determining section 80 updates the correction amount α so that the absolute value of the correction amount α increases. When the correction amount α is updated, the video signal D outputted from the correction section 50 is also updated accordingly, and the above validation process is executed again based on the updated video signal D. The processes as described above are repeated until it is confirmed in the comparison section 902 that the ideal level B2 of the video signal B falls within the video signal range from the lower limit level to the upper limit level.

With the configuration as described above, when the N-1th interpolation frame video signal is corrected in the interpolation frame correcting section 20c, the ideal level of the Nth frame video signal for overdrive is guaranteed to fall within the video signal range from the lower limit level to the upper limit level.

Note that, when the correction amount determining section includes a function capable of determining the correction amount α so that the ideal level of the video signal B for overdrive falls within the video signal range from the lower limit level to the upper limit level, it is understood that the validation section 90 as described above is unnecessary. The following case corresponds to this case. For example, a case where the correction amount determining section inherently includes the function (validation function) of the validation section 90, or a case where the correction amount determining section determines the correction amount α using a lookup table where a value of the correction amount α is set so that the ideal level of the video signal B for overdrive falls within the video signal range from the lower limit level to the upper limit level. Note that, as described above, when the correction of the video signals is performed per plurality of pixels unit (i.e., per block unit, per line unit, or per column unit) or per frame unit, it is difficult to create a lookup table as described above and thus, preferably, a configuration as shown in FIG. 13 is employed in which the validation result obtained by the validation section 90 is fed back to the correction amount determining section 80.

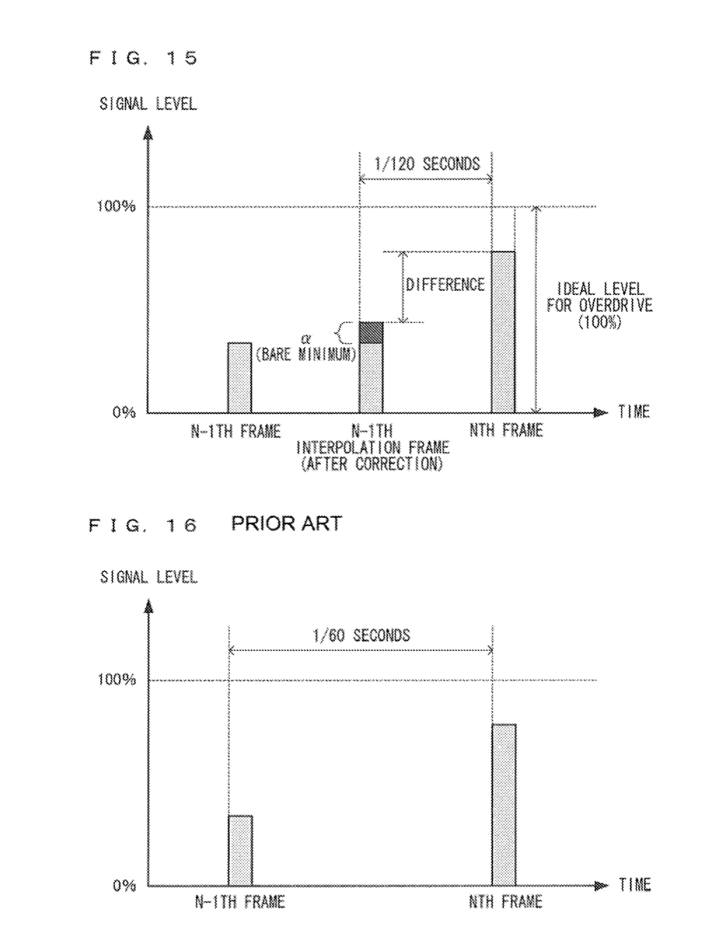

In the interpolation frame correcting section 20a or the interpolation frame correcting section 20b, when the N-1th interpolation frame is corrected, the ideal level of the Nth frame for overdrive does not necessarily match the upper limit level (or the lower limit level) of the video signal, but rather, the ideal level generally becomes lower than the upper limit level (or higher than the lower limit level). However, that the correction of the N-1th interpolation frame lowers the ideal level of the Nth frame for overdrive to a level lower than the upper limit level (or higher than the lower limit level) of the video signal means that the correction amount of the N-1th interpolation frame video signal is not a bare minimum. Preferably, the correction amount of the N-1th interpolation frame video signal is a bare minimum because, if the correction amount of the N-1th interpolation frame video signal becomes unnecessarily greater, so much that a possibility that an image quality is adversely affected (e.g., an image looks more blurred) increases accordingly. The correction amount of the N-1th interpolation frame video signal may be set to a bare minimum by making a slight modification in the interpolation frame correcting section 20c shown in FIG. 13. That is, the validation section 90 may validate whether the ideal level of the Nth frame for overdrive matches the upper limit level (or the lower limit level) of the video signal, and the correction amount α is repeatedly updated (increased or decreased), using a feedback control, up until when the ideal level of the Nth frame for overdrive matches the upper limit level (or the lower limit level) of the video signal (or up until when a deviation falls within a permissible range) (see FIG. 15). However, it is understood that, when the ideal level of the Nth frame for overdrive naturally falls within the video signal range from the lower limit level to the upper limit level without the N-1th interpolation frame being corrected, the ideal level of the Nth frame for override does not need to be matched to the upper limit level (or the lower limit level) of the video signal.

### INDUSTRIAL APPLICABILITY

According to the present invention, even when a frame rate is doubled by repeating video signals of respective frames twice and then resultant video signals are supplied to the overdrive circuitry, the effect of overdrive is sufficiently obtained. The present invention is thus useful as a frame rate conversion device, a frame rate conversion method or the like, for a liquid crystal display device including the overdrive circuitry.

1. A frame rate conversion device for a liquid crystal display device including overdrive circuitry, the frame rate conversion device comprising:
a double-speed conversion section which inserts, between a video signal of an N-1th frame (N is an integer greater than or equal to 2) and a video signal of an Nth frame following the N-1th frame which are input video signals, a video signal of an N-1th interpolation frame at a signal level same as that of the video signal of the N-1th frame, and which outputs resultant video signals at a frame rate twice as high as that of the input video signals; and,
an interpolation frame correcting section which corrects the N-1th interpolation frame video signal outputted from the double-speed conversion section, in accordance with the signal level of the N-1th frame video signal and a signal level of the Nth frame video signal.

2. The frame rate conversion device according to claim 1 wherein the interpolation frame correcting section corrects the N-1th interpolation frame video signal outputted from the double-speed conversion section so that the signal level of the N-1th interpolation frame video signal becomes close to the signal level of the Nth frame video signal.

3. The frame rate conversion device according to claim 1, wherein
the interpolation frame correcting section includes:
a correction amount determining section which determines a correction amount of the N-1th interpolation frame video signal, in accordance with the signal level of the N-1th frame video signal and the signal level of the Nth frame video signal; and
a correction section which corrects the N-1th interpolation frame video signal outputted by the double-speed conversion section, in accordance with the correction amount determined by the correction amount determining section.

4. The frame rate conversion device according to claim 3, wherein
the correction amount determining section includes:
a difference calculating section which calculates a difference between the signal level of the Nth frame video signal and the signal level of the N-1th frame video signal by subtracting the signal level of the N-1th frame video signal from the signal level of the Nth frame video signal; and
a multiplication section which multiplies the difference calculated by the difference calculating section by a predetermined correction factor, wherein
the correction section corrects the N-1h interpolation frame video signal by adding a multiplication result obtained by the multiplication section to the signal level of the N-1th interpolation frame video signal outputted by the double-speed conversion section.

5. The frame rate conversion device according to claim 4 wherein the predetermined correction factor is a value other than 0.5.

6. The frame rate conversion device according to claim 3 wherein the correction amount determining section determines the correction amount of the N-1th frame video signal by referring to a lookup table defining correspondence between the correction amount of the N-1th interpolation frame video signal and combination of the signal level of the N-1th frame video signal and the signal level of the Nth frame video signal.

7. The frame rate conversion device according to claim 1 further comprising:
a correction necessity evaluating section which evaluates whether an ideal level of the Nth frame video signal, in a condition where overdrive is performed by directly inputting into the overdrive circuitry the video signal outputted by the double-speed conversion section, falls within a video signal range from a lower limit level to an upper limit level, wherein
the interpolation frame correcting section corrects the N-1th interpolation frame video signal outputted by the double-speed conversion section only when the ideal level is evaluated not to fall within the range by the correction necessity evaluating section.

8. The frame rate conversion device according to claim 1 further comprising:
a validation section which validates whether an ideal level of the Nth frame video signal, in a condition where overdrive is performed by inputting into the overdrive circuitry the video signal to be outputted by the frame rate conversion device, falls within a video signal range from a lower limit level to an upper limit level, wherein
the interpolation frame correcting section corrects the N-1th interpolation frame video signal outputted by the double-speed conversion section, based on a validation result obtained by the validation section, so that the ideal level of the Nth frame video signal, in a condition where the overdrive is performed by inputting into the overdrive circuitry the video signal to be outputted by the frame rate conversion device, falls within the range.

9. The frame rate conversion device according to claim 1 wherein the interpolation frame correcting section corrects the N-1th interpolation frame video signal outputted from the double-speed conversion section, based on the validation result obtained by the validation section, by using a bare minimum correction amount so that an ideal level of the Nth frame video signal, in a condition where overdrive is performed by inputting into the overdrive circuitry the video signals to be outputted by the frame rate conversion device, falls within the range.

10. The frame rate conversion device according to claim 1 wherein the interpolation frame correcting section corrects each video signal per pixel unit, per plurality of pixels unit, or per frame unit.

11. A frame rate conversion method for a liquid crystal display device including overdrive circuitry, the frame rate conversion method comprising:
a double-speed conversion step of inserting, between a video signal of an N-1th frame (N is an integer greater than or equal to 2) and a video signal of an Nth frame following the N-1th frame which are input video signals, an N-1th interpolation frame video signal at a signal level same as that of the N-1th frame video signal, and outputting resultant video signals at a frame rate twice as high as that of the input video signals; and
an interpolation frame correcting step of correcting the N-1th interpolation frame video signal inserted by the double-speed conversion step, in accordance with the signal level of the N-1th frame video signal and a signal level of the Nth frame video signal.
